(19) United States
(12) Patent Application Publication
(10) Pub. No.: US 2024/0080197 A1
(43) Pub. Date: Mar. 7, 2024

(54) HARDWARE ACCELERATOR FOR COMPUTING A SCALAR DOT PRODUCT

(71) Applicant: INGONYAMA LTD., Petach Tikva (IL)

(72) Inventors: Daniel SHTERMAN, Petach Tikva (IL); Omer SHLOMOVITS, Petach Tikva (IL); Michael ASA, Kfar Sava (IL); Yuval DOMB, Raanana (IL)

(73) Assignee: INGONYAMA LTD., Petach Tikva (IL)

(21) Appl. No.: 17/903,647

(22) Filed: Sep. 6, 2022

(51) Int. Cl. H04L 9/32; G06F 7/72; G06F 17/16

(52) U.S. Cl. CPC H04L 9/3218; G06F 7/725; G06F 17/16

(57) ABSTRACT

A hardware accelerator computes a scalar dot product given by Σᵢ₌₀^{N-1}dᵢPᵢ where dᵢ is a scalar of length b bits and Pᵢ is an element in a group. The hardware accelerator includes a plurality A of accumulators addressed by corresponding contiguous partitions of the scalar dᵢ, each partition being of length c such that

$$A = ⌈ \frac{b}{c} ⌉$$

and each accumulator containing a plurality B of buckets where B=2^{c}. The value of Pᵢ is entered into each empty accumulator bucket whose value corresponds to the weight of the respective partition associated with the corresponding accumulator or is added to a non-zero value that is already in the bucket, the sum replacing the previous value. An accumulator sums the values in the respective buckets of each accumulator so as to derive A sums, and sums the A computed sums to derive the scalar dot product.

### FIELD OF THE INVENTION

This invention relates generally to firmware for the computation of vector multiplication and more specifically to use thereof in proof generation and proof verification for the zk-SNARK protocol.

### BACKGROUND OF THE INVENTION

zk-SNARK is an acronym for “Zero-Knowledge Succinct Non-Interactive Argument of Knowledge,” and refers to a proof construction where one can prove possession of certain information, e.g., a secret key, without revealing that information, and without any interaction between the prover and verifier. Zero-knowledge algorithms are used in encryption systems to allow users to demonstrate that they are authorized to carry out a transaction by submitting a statement that reveals no information beyond the validity of the statement itself. Proof of legitimacy is not a rigorous mathematical proof but, rather, a statistical construct based on the improbability of a highly complex mathematical computation reaching a correct solution starting from an incorrect or fraudulent hypothesis.

US20210266168 discloses a hardware accelerator for accelerating the zk-SNARK protocol by reducing the computation time of the cryptographic verification. In one embodiment, the accelerator includes a zk-SNARK engine having at least four processing units running in parallel, each comprising one or more multiply-accumulate operation (MAC) units; one or more fast Fourier transform (FFT) units; and one or more elliptic curve processor (ECP) units. The ECP units are configured to reduce a bit-length of a scalar dᵢ in an ECP algorithm used for generating a proof, whereby the cryptographic verification requires less computation power.

The cryptographic verification is executed on a dedicated semiconductor device configured to offer massive parallelism targeted for specific zk-SNARK algorithms, and programmable to change the algorithms. It is noted that this may be implemented using one or more processors, such as a digital processor, an analog processor, a CPU, a microcontroller, a state machine, or other electronic processing units.

The ECP algorithm is:

$${R}_{i} = {\sum }_{i = 0}^{N - 1} {d}_{i} {P}_{i}$$

where:
N=2ⁿ;
n>11
dᵢ is a scalar; and
Rᵢ and Pᵢ are points on an elliptic curve.

The acceleration achieved in above-referenced US20210266168 is the result of a combination of custom hardware and an improved ECP algorithm configured to calculate the summation of dᵢPᵢ in a faster way resulting in a five-fold reduction in the number of clock cycles required to complete the computation. The hardware accelerator can reduce the bit-length of the scalar dᵢ such that the computation power required for performing multiplication of the scalar dᵢ with the elliptic point Pᵢ is reduced.

### SUMMARY OF THE INVENTION

It is an object of the present invention to provide a hardware accelerator configured to perform the Multi-Scalar Multiplication algorithm (referenced above as ECP algorithm) while having improved performance over known approaches.

It is acknowledged that US20210266168 also proposes parallel-processing in order to achieve faster computation. However, as will become clear from the following description, the present invention employs novel hardware allowing computation of the scalar dot product to be implemented recursively using a pipeline that allows dᵢPᵢ to be computed by a repeated elliptic curve addition.

To this end, the accelerator according to the invention, splits each scalar value, dᵢ (usually called scalar or coefficient) into a number of sequential chunks of bits, denoted by nc. If the number of bits in such a chunk is c then nc=ceiling(width(dᵢ)/c). Each chunk enumerated d_{i,j} has an accumulator associated with it when each accumulator has memory of size 2^{c}×width(Pᵢ). Each entry in this memory is called a bucket. Value of j points to the specific accumulator when d_{i,j} points to the specific bucket in the accumulator.

The buckets are used to store cumulative additions of the elements Pᵢ (usually called points or bases) each bucket corresponding to a different chunk stored in a block of memory. Each element is a point Pᵢ on an elliptic curve, which may be represented in 3-D space by Cartesian coordinates (xᵢ, yᵢ, zᵢ). Any other coordinates, such as Jacobian, Projective etc., could be used.

By way of example, when used to implement the zk-SNARK protocol, the scalar dᵢ may have a length of 253 bits. The register storing an instantaneous value of dᵢ may be divided into 29 chunks of 9 bits (since 29×9=261), which can accommodate a 253-bit number. Each 9-bit chunk points to one of 512 buckets in one of 29 accumulators (since 2⁹=512). Note that in this case the difference in weight in the final result between two adjacent accumulators is 2⁹. So, in an initial cycle, in each of the accumulators the bucket addressed by the respective 9-bit chunk of d₁ is set to the value of P₁. If, at this stage, we were to add the results in all the accumulators, we would obtain the cumulative value of d₁×P₁. Note that accumulators' weights are taken into account during this addition process. During the second iteration, the scalar d₂ now points to a new set of buckets in each of the 29 accumulators. Depending on whether the respective block of 9 bits points to the same bucket as the previous iteration or to a different bucket in the same accumulator, we need to add P₂ to the current value P₁ if it's the same bucket as d₁ or set a new bucket to P₂. Therefore, a new value of the accessed bucket depends on its state before the access. In general, for iteration i, if the bucket is empty then the value of Pᵢ is written into the bucket. Otherwise, the bucket's value in each accumulator is fed to the first input of a 2-input elliptic curve adder (constituting a first adder) to whose second input is fed Pᵢ. The result of the elliptic curve addition is stored back into the bucket. In a practical implementation, there may be multiple EC adders to improve performance so as to allow more EC additions to be performed in parallel, where the number of adders should not exceed the number of accumulators. However, for ease of description, we shall continue to refer to the EC adder in the singular. So, for the n-th cycle, the output of the 2-input adder corresponds to the sum Σᵢ₌₁ⁿdᵢPᵢ for the respective bucket and this value is now stored in the bucket and replaces any previous value. Multiplexer logic is used when the number of elliptic curve adders is less than the number of accumulators. In this case, each elliptic curve adder should be provided with the information to which accumulator to return the result. The elliptic curve adder is a fully pipelined logic, therefore its bandwidth is one operation per clock.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 depicts the block diagram of a system according to the invention that performs MSM calculations;

FIG. 2 is a block diagram showing a detail of the MSM module used in the system of FIG. 1 to perform the MSM calculations;

FIG. 3 depicts all the stages of MSM calculations including the data and the control flow;

FIG. 4 is a flow diagram depicting the principal operations carried out by the system shown in FIG. 1 during computation of MSM;

FIG. 5 depicts a symbolic representation of the fully pipelined Elliptic Curve Adder which consists of different modular multipliers, adders, subtractors, pipeline registers and fine-tuned delays; and

FIG. 6 is a schematic representation of the bucket accumulators used in a simplified implementation of the invention.

### DETAILED DESCRIPTION OF EMBODIMENTS

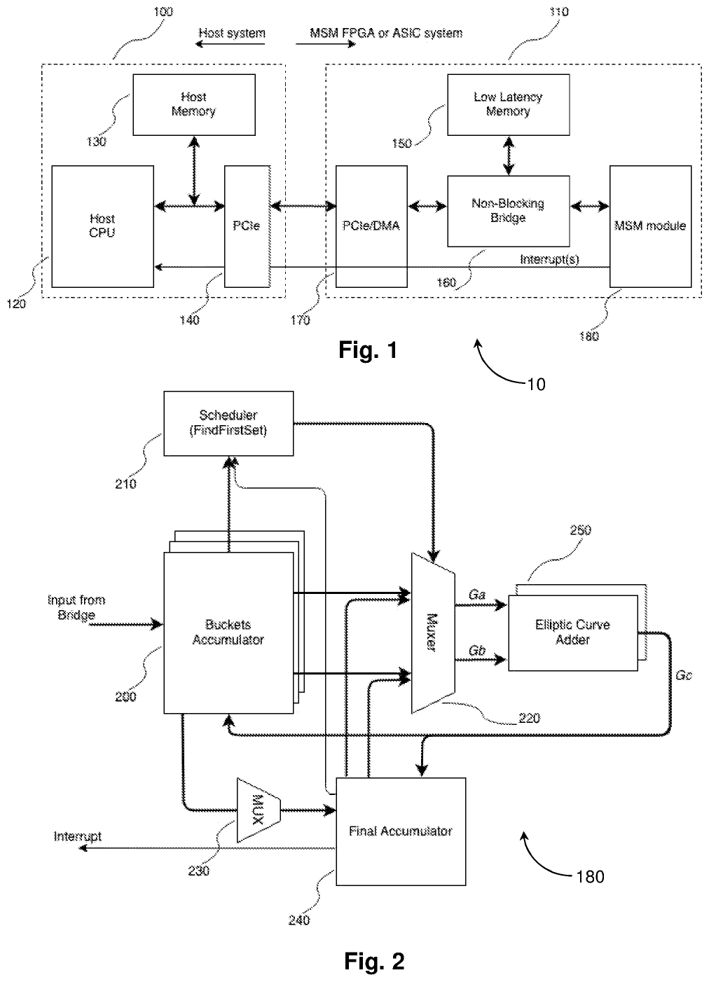

FIG. 1 is a block diagram that shows the functionality of an MSM system 10 comprising a host system 100 and an MSM subsystem 110 coupled via PCIe (Peripheral Component Interconnect Express). The MSM subsystem 110 may be implemented by using an FPGA or a dedicated or programmable ASIC. The host system 100 comprises a host CPU subsystem 120, host memory 130 and PCIe controller 140. The MSM subsystem 110 comprises a PCIe/DMA module 170, non-blocking bridge 160, low latency memory 150 and MSM module 180.

The host CPU 120 runs a user application program, which builds the data needed for the compilation of the MSM and stores the data in the host memory 130 usually implemented by DDR (double data rate). Usually zk-SNARK protocol proofs need the MSM to be executed multiple times when for some of the times the Pᵢ's (coordinates) of a particular MSM are known ahead of time and in some cases these coordinates are functions of the previously calculated MSM. If the coordinates are known ahead of time, they can be preloaded into the low latency memory 150 of the MSM subsystem. All the communication between the host system and the MSM system is done by using PCIe 140, 170. PCIe enables high bandwidth data transfer between the host memory 130 and the MSM subsystem 110.

The manner in which the MSM subsystem 110 is used in the zk-SNARK protocol is well-described in US20210266168, although they are both implemented using a combination of hardware and software. The present invention achieves improved performance using a novel hardware configuration which employs logic elements to direct the flow of data in a pipelined manner, thus allowing parallel processing without the overhead of conventional software.

In the MSM subsystem 110 use of the non-blocking bridge 160 and low-latency memory 150 is preferable because of the high bandwidth typically needed in MSM applications particularly when used for computationally-demanding applications such as zk-SNARK. Specifically, the memory is used to store data that must be accessed by the MSM subsystem and speed of operation is therefore dependent to some extent on the speed of the memory. However, the invention may also be used for less computationally-demanding applications where high-speed memory access is less critical. The MSM module 180 gets all the data needed for the MSM calculation from PCIE/DMA 170 and/or low-latency memory 150. There are queues on the MSM module inputs in order to absorb burst accesses of data.

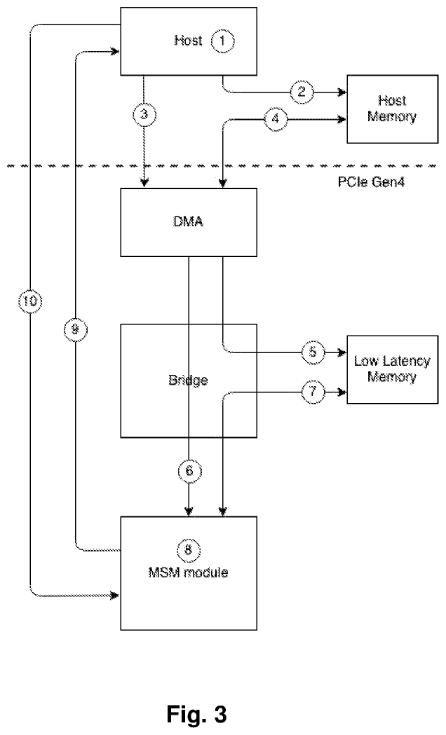

FIG. 2 is a block diagram of the MSM module 180. This module includes a number of buckets accumulators 200, a scheduler 210, and a muxer 220 having two pairs of inputs each switchable to respective outputs. The buckets accumulators 200 are coupled to a final accumulator 240 optionally via an associated multiplexer 230 and to an elliptic curve adder 250. The figure shows schematically a bank of elliptic curve adders since there may be more than one, in which case there must also be an equal number of muxers 220, even though for the sake of simplicity only one is shown in the figure. All the muxers are coupled to all of the accumulators and the scheduler 210 selects a different accumulator to be served for each elliptic curve adder so as to feed the respective contents of a selected bucket in each selected accumulator via a respective muxer 220 to a different elliptic curve adder 250. An advantage of having multiple adders is that multiple accumulators can be served simultaneously, thus allowing multiple additions to be performed in parallel. The exact number of the buckets accumulators is ceiling(width(dᵢ)/c) where c is the width of the coefficient chunk as described in the Summary above. Each buckets accumulator has 2^{c} number of entries. These entries are initialized to a coordinate with a zero value upon system reset, it being understood that each value of Pᵢ is a point on the elliptic curve, which represents a point in 3-D space having three coordinates. When the coordinate is presented to the buckets accumulator from the bridge, the bucket entry pointed by dᵢⱼ (as defined above) is checked if it already has meaningful data. If not, then the coordinate value is written to the entry pointed by dᵢⱼ. If yes, then this value together with the newly arrived value are sent to the elliptic curve adder. The particular entry is marked as invalid until the output from the elliptic curve adder will arrive or a new input from the bridge will arrive. The bridge may in some embodiments be regarded as a selector for selecting a bucket in each accumulator corresponding to a weight of the respective partition associated with the corresponding accumulator. The weight of the partition is equal to the partial value of the scalar represented by the 9 bits of the scalar associated with the corresponding accumulator. The bridge may be implemented by a 9-input multiplexer having 512 outputs, only one of which is selected according to the partial value of the scalar represented by the 9-bit partition. However, more generally it should be understood that the manner in which data is passed from the host to the MSM module 180 is a function of the host system 100 and does not impact the manner in which the MSM module 180 operates. What is important, however, is that the host system 100 simultaneously feeds values corresponding to successive weights of respective partitions to a plurality of accumulators for updating a bucket in each respective accumulator. The bucket in each accumulator that is thus updated is identified by the weight of the partition, as defined above, and constitutes an active bucket. Since the invention achieves high processing speed by addressing multiple buckets simultaneously in a pipeline configuration, at any given instant there will be multiple active buckets.

After the input with the last indication arrives from the bridge, the buckets accumulators perform their last aggregation calculation and start the partial sums calculation phase. In this phase the calculation is performed in a way that a weight of each one of the buckets in the buckets accumulator is taken into account.

Upon completion of the partial sums phase the results from the buckets accumulators are transferred to the final accumulator module for final calculations of all the buckets accumulators when the weights of the buckets accumulator (i.e., hundreds, ten, units etc.) are taken into account.

When the number of the buckets accumulators is greater than the number of elliptic curve adders 250 then there is a need for the scheduler 210 and the muxer 220 in order to select the next buckets accumulator(s) to be served. The elliptic curve adder receives two operands Gₐ and G_{b} as its inputs and generates after some number of clocks the output G_{c}. Along with the operands Gₐ and G_{b} the elliptic curve adder receives the index of the buckets accumulator that generated the transaction and the bucket's address of this buckets accumulator. The elliptic curve adder output, G_{c} is provided to one of the buckets accumulators (based on the index of the buckets accumulator provided to the elliptic curve adder input) or to the final accumulator. When provided to the particular buckets accumulator, the entry that is addressed by the pointer provided to the elliptic curve adder as its input is checked to determine if it holds valid coordinate data. If the entry is not valid then the data is just written into the entry. Otherwise, the entry data together with the result data are fed to the elliptic curve adder together with the index and address of the buckets accumulator, and the cycle is repeated recursively. The index specifies which buckets accumulator is selected and the address specifies which bucket in the selected bucket accumulator is being accessed. Alternatively (as a backup), the final accumulator 240 may access the data in the buckets accumulators by using the optional multiplexer 230. More generally, the final accumulator 240 receives its inputs directly from the elliptic curve adder(s) 250.

FIG. 3 depicts all the stages of MSM calculations including the data and the control flow. The flow starts with the host that runs the user application (1). The user application may be zk-SNARK proof generation, which makes extensive usage of MSM calculation. The Host loads the data that could be precalculated or downloaded from somewhere into the Host Memory (2). E.g. Host loads the values of the coefficient (di) and coordinates (Pi) that are public knowledge. Not always can the data be loaded ahead of time, since it may be a result of previous calculations.

Host configures the DMA module (3). This module will be used later for a fast movement of the data between Host Memory, MSM system Low Latency Memory and the MSM module. Based on preconfigured blocks descriptions, the DMA transfers the data from the Host Memory to the desired destination (either Low Latency Memory or MSM module) (4), (5) and (6). If needed the MSM module loads additional data from the Low Latency Memory that was previously preloaded by using the DMA (7). The MSM module performs all the required calculations (8). These calculations could be performed in Affine, Jacobian, Projective and any other suitable type of coordinates. Processes (7) and (8) are repeated as needed until the end of calculations for the particular MSM. Upon completion of the calculations the MSM module informs the host by using an interrupt that the MSM calculation result is available to be read (9). In order to better use the MS system resources there is a possibility to use more than a single interrupt while an earlier interrupt informs the host that a new MSM calculations cycle could start even before the final accumulator completed its task. The host reads the MSM calculation result from the MSM subsystem (10).

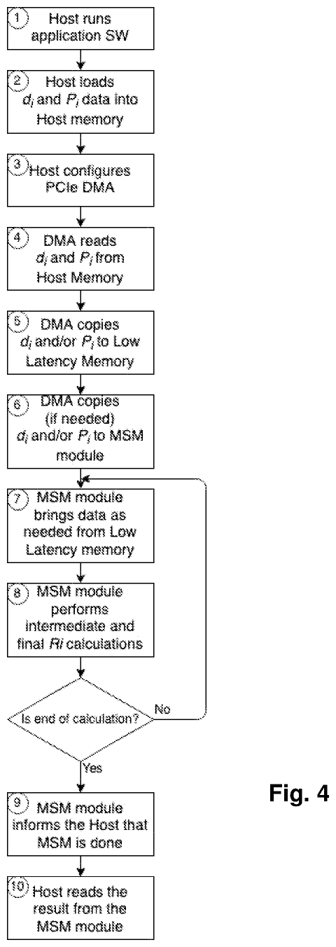

FIG. 4 is a flow diagram depicting the principal operations carried out by the MSM system 10 show in FIG. 1, which is implemented by fully pipelined logic, such that the input of the elliptic curve adder can be fed with the new data every clock cycle and provides a new output every clock cycle. The logic of the elliptic curve adder comprises modular multipliers, adders, subtractors and sequential elements. Delays implemented by the sequential elements are used to synchronize different paths through the elliptic curve adder, in order to ensure that each element in the system is coordinated with the time of arrival of data.

It is seen that the host runs application software, which in one application of the invention may be proof generation and proof verification for the zk-SNARK protocol. The host loads values of dᵢ and Pᵢ into the host memory 130 and configures the PCIe/DMA module 170. The PCIe/DMA module 170 reads the values of dᵢ and Pᵢ from the host memory 130 and copies these values to the low latency memory 150 and, when necessary, also to the MSM module 180. The MSM module 180 reads the values of dᵢ and Pᵢ as needed from the low latency memory 150 and performs intermediate and final calculations as described above, this being repeated as necessary until all values of dᵢ and Pᵢ have been completely processed. When complete, the MSM module 180 informs the host, which reads the result from the MSM module 180.

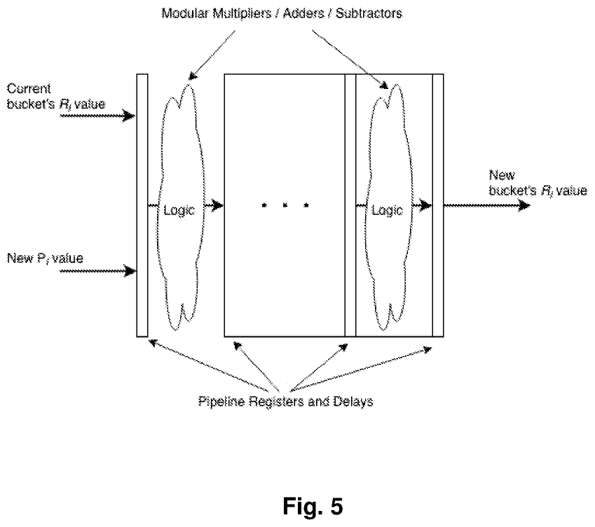

FIG. 5 depicts a symbolic representation of the fully pipelined Elliptic Curve Adder which consists of different modular multipliers, adders, subtractors, pipeline registers and fine-tuned delays.

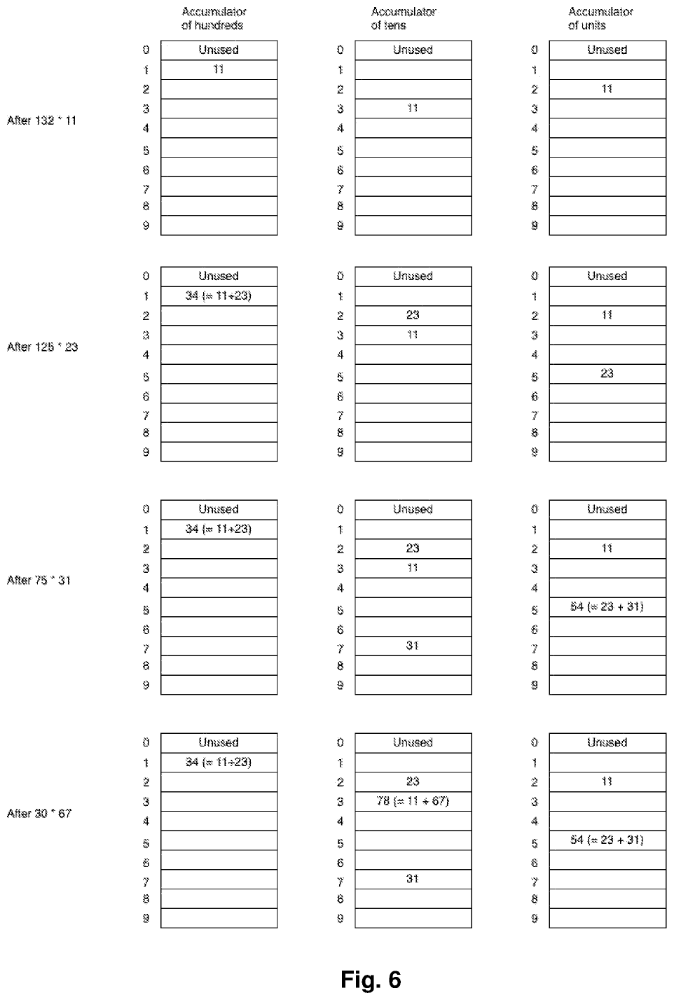

FIG. 6 depicts an example of the algorithm described in this invention, as described in detail below.

### Algorithm Detailed Description by Example

Thus, in order to clarify the generality of the MSM module 180, we will describe an implementation for computing the scalar dot product of two vectors each having four elements using base-10 arithmetic. Let us suppose that we have two vectors as follows:
d=132, 125, 75, 30
P=11, 23, 31, 67

Thus,
d₀=132, d₁=125, d₂=75 and d₃=30P₀=11, P₁=23, P₂=31 and P₃=67

The scalar dot product is given by:

$$R = {\sum }_{i = 0}^{N - 1} {d}_{i} {P}_{i}$$

Therefore:

R=132*11+125*23+75*31+30*67=8,662

This is easily implemented in software using a nested for loop, but is very time-consuming when N is large. Nevertheless, it will facilitate clearer understanding of the invention to demonstrate how the computation is performed using the hardware module according to the invention. Note that there is no multiplication operation in Elliptic Curve arithmetic. There is only one operation defined: Elliptic Curve Add. Therefore, in order to implement multiplication by N there is a need for N−1 Elliptic Curve Additions.

We can rewrite the above equation as:

R=1*11*100+3*11*10+2*11*1+1*23*100+2*23*10+5*23*1+0*31*100+7*31*10+5*31*1+0*67*100+3*67*10+0*67*1

Since all elements dᵢ of the vector d are smaller than 999, we can represent the i-th multiplication dᵢPᵢ in the scalar dot product as the sum of three partial products that relate to the hundreds, tens and units, respectively for each value of dᵢ. These values are stored in respective accumulators each having ten separate memories, known as ‘buckets’, into which are deposited the cumulative partial products for each iteration. Once this is done, the values in each of the ten buckets for each accumulator are summed while taking into account the weight of each bucket. For example, in the tens-accumulators the weight of bucket at address 9 is 9 while the weight of the bucket at address 5 is 5. After each of the accumulators has summed up all its buckets all three accumulators are summed in order to yield the scalar dot product. This summation should take into account the weights of the accumulators. Thus, in our example, the weight of the hundreds-accumulator is 100 while the weight of the tens-accumulator is 10.

Since this example represents a very specific application, which while useful for the purpose of explanation is far removed from a practical application of the invention, we should explain why three accumulators each having ten buckets suffice for this example. We need three accumulators because we have elected to group the scalars dᵢ into three separate partitions or segments, corresponding in this case to hundreds, tens and units. And we need ten buckets in each accumulator because for each of these groups there are ten different values (i.e., digits) associated with each partition.

However, this is specific to this example. If dᵢ were a decimal number not exceeding 9,999, then we could represent the i-th multiplication dᵢPᵢ in the scalar dot product as the sum of four partial products that relate to the thousand, hundreds, tens and units, respectively for each value of dᵢ. This could be done using four accumulators each having ten buckets. Alternatively, we could group the thousands and hundreds as a first partition and the tens and units as a second partition represented by only two accumulators each having 10² i.e., 100 buckets to accommodate all possible combinations.

In a practical implementation of the invention used to implement the zk-SNARK protocol, the scalar, dᵢ is a 253-bit binary value, which is partitioned into 29 segments each of which requires 9 bits since anything less would not be able to represent the complete 253-bit value 29*8=232 and is too small. The 29 segments require 29 accumulators each having 2⁹=512 buckets. But it will be understood that this could also be realized with fewer accumulators each having more buckets to represent fewer larger partitions having more than 29 bits. Alternatively, we could employ more accumulators each with fewer buckets to represent a larger number of smaller partitions having less than 29 bits.

The decision as to whether to partition the scalar into fewer partitions each with more buckets or into larger partitions each with fewer buckets is basically a tradeoff between performance and the accumulators' memory size. The larger the number of the accumulators, the more partial products can be computed in parallel since all the accumulators can be addressed together in a single clock cycle.

Reverting to the above decimal example, where d=132, 125, 75, 30 and P=11, 23, 31, 67, we have three accumulators, which are shown in FIG. 6 as “Accumulator of hundreds”, “Accumulator of tens” and “Accumulator of units” each having ten buckets, numbered 0 to 9. For ease of description, we will refer to these as hundreds-accumulators, ten-accumulators and units-accumulators, respectively. It should be noted that the numbers are shown for ease of explanation and are not actually stored, but serve as address lines by means of which any bucket may be accessed for both read and write operations to a desired bucket. Associated with each accumulator is a buffer (not shown), which is used to hold the current contents of an addressed bucket when it is required to write new data to the same bucket. Finally, associated with each bucket is a flag (also not shown) which is used to indicate whether or not the bucket contains valid data. We assume, for the sake of example, that the flag is set to “1” when the bucket contains valid data and is otherwise zero. The structure of the accumulators shown in the figure is schematic and is not intended to depict the actual configuration. The flags can be stored in a completely separate memory having ten addressable memory locations, corresponding to the ten buckets and addressed via the same address bus as the accumulator. Likewise, the buffer can be a separate memory. Note that the zero location of the accumulators is not used because its weight is zero. It should also be noted that in an alternative implementation, all buckets can be filled with zero on initialization since zero is an invalid entry. When a bucket is filled with valid data for the first time, the data is entered directly into the bucket and replaces the zero entry that was initially entered. When new data is to be entered (actually summed) to the same bucket, the current non-zero value is first copied to the buffer. In the following description, it is assumed by way of example only that validity flags are used.

Computation of the scalar dot product requires iteratively populating the buckets as will now be explained, it being first noted that because separate, mutually independent accumulators are used to keep tally of the hundreds, they can be addressed in parallel during the same clock cycle. Thus, in the case where:

Rᵢ=100*11+30*11+2*11

we start by placing 11 corresponding to P₁ in the first bucket of the hundreds-accumulator, the third bucket of the tens-accumulator and the second bucket of the units-accumulator. This is done by a direct write access to the corresponding buckets, after which their corresponding validity flags are set to 1 to indicate that these buckets now contain valid data. For the second line, we need to add 23 corresponding to P₂ to the first bucket of the hundreds-accumulator, the second bucket of the tens-accumulator and the fifth bucket of the units-accumulator. In the case of the tens and units, the corresponding buckets are both empty and so 23 can be placed directly into the second bucket of the tens-accumulator and the fifth bucket of the units-accumulator, after which their corresponding validity flags are set to 1. But we cannot directly place 23 into the first bucket of the hundreds-accumulator because its validity flag is set to 1, indicating that it contains valid data, i.e., 11 from the previous recursion.

When we encounter such a situation that we need to enter data into a bucket that already contains data, we need to add the new value to the existing value. To do this, we set the buffer to the current value, in this case 11, and then initialize the bucket either by emptying it or simply by setting its validity flag to zero. The new value of 23 corresponding to P₂ is now conveyed together with the data in the buffer, currently equal to P₁ to the Elliptic Curve Adder, which adds the two values 11+23 and feeds the sum back to the hundreds-accumulator. Referring to the schematic implementation in FIG. 2, it is seen that two lines Gₐ, G_{b} are fed to the Elliptic Curve Adder from a selected bucket and a single line G_{c} is returned from the Elliptic Curve Adder to the same bucket. By way of explanation, it is noted that the two lines Gₐ, G_{b} are fed via a 29:1 multiplexer (assuming a single Elliptic Curve Adder) because in the embodiment of FIG. 2 there are 29 accumulators, each having 512 buckets. A logic element 210 referred to as “Scheduler (FindFirstSet)” is coupled to all the accumulators and serves to scan through all the validity flags of each accumulator to find the first bucket for which the flag is set to “1”. The index of this bucket is fed to the 29:1 multiplexer to select the accumulator to be served.

At the end of this process, it can be seen that the hundreds-accumulator has a single entry 34 in bucket 1. This sum of all values in this accumulator is therefore equal to 100×34. The tens-accumulator has three entries 23, 78 and 31 in buckets 2, 3 and 7, respectively. The sum of these values is therefore equal to 20×23+30×78+70×31. The units-accumulator has two entries 11 and 54 in buckets 2 and 5, respectively. The sum of these values is therefore equal to 2×11+5×54. Note that when dealing with a large number of inputs the probability to have an empty bucket is small.

The last operation requires accumulating all the buckets accounting their respective weights and is performed in two phases. The first phase is accumulating all the ten buckets in each accumulator and the second phase is accumulating all the three results into the solution of the MSM problem.

The algorithm to sum up the buckets implements the following pseudocode:
buckets_sum=0
weighted_buckets_sum=0
for idx 9->0

buckets_sum=buckets_sum+bucket[idx]

weighted_buckets_sum=weighted_buckets_sum+buckets_sum

At the end of this process, the final result will be at weighted_buckets_sum. Note that the number of times each bucket was added to weighted_buckets_sum is exactly the weight of the buckets. Running the algorithm on our example will provide for the hundreds-accumulator: 1×34=34. For the tens-accumulator: 2×23+3×78+7×31=497, and for the units-accumulator: 2×11+5×54=292.

The algorithm may be executed in firmware, which constitutes a second adder that may be part of the MSM module 180. However, the number of computations required for each accumulator is equal to the number of buckets in each accumulator less 1. So even in the case where there are 512 buckets in each accumulator as proposed for use in the proof generation and proof verification for the zk-SNARK protocol, the cost overhead in implementing this phase in software is not critical.

The algorithm to sum up the accumulator values implements the following pseudocode:
final_msm_result=accumulator[2]
for idx 1->0

final_msm_result=10*final_msm_result

final_msm_result=final_msm_result+accumulator[idx]

The algorithm may be executed in firmware, which constitutes a third adder that may be part of the MSM module 180. However, at this stage the number of iterations required to sum up the accumulator values is equal to the number of accumulators less 1. So even in the case where there are 29 accumulators as proposed for use in the proof generation and proof verification for the zk-SNARK protocol, the cost overhead in implementing this phase in software is not critical. At the end of this process the result will be at final_msm_result. At the beginning accumulator_sum will be initialized to 34. At the end of the first iteration, it will be equal to 10×34+497=837. At the end of the second iteration, it will be equal to 10×837+292=8,662 which is the result of the MSM calculation.

When the accumulators send their data to the final accumulator, a new MSM calculation can commence whereby data is fed to the buckets from the memory in parallel with the final accumulator summing the results of the previous computation, thereby saving time since two different computer resources are used simultaneously.

As noted above, one practical application of the invention is proof generation and proof verification for the zk-SNARK protocol, wherein the scalar dᵢ is of length 253 bits and the MSM is performed using 29 accumulators each having 512 buckets. The hardware implementation according to the invention allows for the respective buckets in each accumulator to be written in parallel, thus allowing for up to 29 operations to be performed simultaneously. Multiplication is performed by repeated addition to those buckets in each accumulator for which the coefficient of the multiplicand for the respective bucket is non-zero. It is reiterated that the division between accumulators and buckets is a tradeoff between the number of operations that can be performed in parallel and the memory size of the accumulators.

It will also be understood that while the invention has been described with reference to proof generation and proof verification for the zk-SNARK protocol, the invention has more general application. Specifically, while the zk-SNARK protocol utilizes the ECP algorithm based on the multiplication of a scalar dᵢ with a point Pᵢ on an elliptic curve, the invention is not restricted for use with elliptic addition and the point Pᵢ can more generally be an element in a group. In mathematics, a group is a set and an operation that combines any two elements of the set to produce a third element of the set, in such a way that the operation is associative, an identity element exists and every element has an inverse.

It will also be appreciated that the invention relates principally to the construction and operation of the MSM module 180 shown in FIG. 1. Thus, while a complete system is described this is done for the sake of completeness and by way of example and not by way of restriction. For example, it is convenient to store the values of dᵢ and Pᵢ in memory and for the host to feed these values from memory to the MSM module. But from the perspective of the MSM module it really makes no difference how these values are acquired by the MSM module. For example, either or both values could be computed on-the-fly and fed to the MSM module without the need for them to be stored.

1. A hardware accelerator for computing a scalar dot product given by:
$${\sum }_{i = 0}^{N - 1} {d}_{i} {P}_{i}$$
where:
dᵢ is a scalar of length b bits; and
Pᵢ is an element in a group;
wherein the hardware accelerator comprises:
a plurality A of accumulators addressed by corresponding contiguous partitions of the scalar dᵢ, each of said partitions being of length c such that
$$A = ⌈ \frac{b}{c} ⌉$$
and each accumulator containing a plurality B of buckets where B=2^{c},
each of the accumulators having a respective buffer for storing the value of an active bucket in the respective accumulator, the active bucket corresponding to a weight of the respective partition associated with the corresponding accumulator,
each of the accumulators being responsive to the active bucket containing valid data for placing said data into the respective buffer and identifying the bucket as valid and being responsive to the bucket being available for placing Pᵢ into the selected bucket and identifying the bucket as valid,
a scheduler coupled to at least one multiplexer having A inputs and a single output, the scheduler being configured to select as many of the accumulators as there are multiplexers for coupling the data in a respective selected bucket of each selected accumulator to the output of the respective multiplexer,
for each multiplexer, a respective first adder having a first input and a second input and an output equal to the sum of the first input and the second input, the first input being coupled to the output of the respective multiplexer, the second input being configured for obtaining the value of Pᵢ, the output of each first adder being entered into the respective selected bucket, and
a final accumulator coupled to the respective output of each first adder for summing the values in the respective buckets of each accumulator so as to derive A sums, and summing the A computed sums to derive the scalar dot product.

2. The hardware accelerator according to claim 1, further including:
a respective bucket status memory associated with each of the buckets, wherein each bucket status memory is set to a first value indicating that the corresponding bucket is available and to a second value indicating that the corresponding bucket contains valid data.

3. The hardware accelerator according to claim 1, wherein the final accumulator comprises:
a second adder coupled to the output of the first adder for summing the values in the respective buckets of each accumulator so as to derive A sums, and
a third adder coupled to the output of the second adder for summing the A sums computed by the second adder.

4. The hardware accelerator according to claim 1, wherein Pᵢ is a point on an elliptic curve and each first adder is an elliptic curve adder.

5. The hardware accelerator according to claim 4, when used to compute a scalar dot product during implementation of proof generation or proof verification for the zk-SNARK protocol.

6. The hardware accelerator according to claim 1, wherein the at least one first adder comprises at least two adders configured for operating simultaneously in a pipelined manner.

7. A system configured for computing a scalar dot product given by:
$${\sum }_{i = 0}^{N - 1} {d}_{i} {P}_{i}$$
where:
dᵢ is a scalar of length b bits; and
Pᵢ is an element in a group;
said system comprising:
a first memory of length b bits for storing successive values of dᵢ,
a second memory for storing successive values of Pᵢ,
a plurality A of accumulators coupled to the first memory and addressed by corresponding contiguous partitions of the scalar dᵢ, each of said partitions being of length c such that
$$A = ⌈ \frac{b}{c} ⌉$$
and each accumulator containing a plurality B of buckets where B=2^{c},
each of the accumulators having a respective buffer for storing the value of an active bucket in the respective accumulator, the active bucket corresponding to a weight of the respective partition associated with the corresponding accumulator,
each of the accumulators being further coupled to the second memory and being responsive to the active bucket containing valid data for placing said data into the respective buffer and identifying the bucket as valid and being responsive to the bucket being available for placing Pᵢ into the selected bucket and identifying the bucket as valid,
a scheduler coupled to at least one multiplexer having A inputs and a single output, the scheduler being configured to select as many of the accumulators as there are multiplexers for coupling the data in a respective selected bucket of each selected accumulator to the output of the respective multiplexer,
for each multiplexer, a respective first adder having a first input and a second input and an output equal to the sum of the first input and the second input, the first input being coupled to the output of the respective multiplexer, the second input being configured for obtaining the value of Pᵢ, the output of each first adder being entered into the respective selected bucket, and
a final accumulator coupled to the respective output of each first adder for summing the values in the respective buckets of each accumulator so as to derive A sums, and summing the A computed sums to derive the scalar dot product.

8. The system according to claim 7, further including:
a respective bucket status memory associated with each of the buckets, wherein each bucket status memory is set to a first value indicating that the corresponding bucket is available and to a second value indicating that the corresponding bucket contains valid data.

9. The system according to claim 7, wherein the final accumulator comprises:
a second adder coupled to the output of the first adder for summing the values in the respective buckets of each accumulator so as to derive A sums, and
a third adder coupled to the output of the second adder for summing the A sums computed by the second adder.

10. The system according to claim 7, wherein Pᵢ is a point on an elliptic curve and each of the at least one first adder is an elliptic curve adder.

11. The system according to claim 10, when used to compute a scalar dot product during implementation of proof generation or proof verification for the zk-SNARK protocol.
